(19) United States
(12) Patent Application Publication
(10) Pub. No.: US 2025/0348551 A1
(43) Pub. Date: Nov. 13, 2025

(54) SELECTABLE IMAGES FOR ASSOCIATION WITH NETWORK IDENTIFIERS

(71) Applicant: Apple Inc., Cupertino, CA (US)

(72) Inventors: Timothy P. HORTON, Santa Clara, CA (US); Elliot A. BARER, Sunnyvale, CA (US)

(21) Appl. No.: 19/078,168

(22) Filed: Mar. 12, 2025

Related U.S. Application Data
(60) Provisional application No. 63/647,061, filed on May 13, 2024.
(60) Provisional application No. 63/657,966, filed on Jun. 9, 2024.

(51) Int. Cl. G06F 16/955; H04L 67/02

(52) U.S. Cl. CPC G06F 16/955; H04L 67/02

(57) ABSTRACT

Aspects of the subject technology provide for receiving a uniform resource locator (URL) at a messaging application and obtaining images from a webpage. A subset of the images is determined and presented to a user device for selection. A selection is received and the selected image is provided in a message input element to send in association with the URL.

### CROSS REFERENCE TO RELATED APPLICATIONS

This application claims the benefit of U.S. Provisional Application No. 63/647,061, entitled “Selectable Images For Association With Network Identifiers,” filed May 13, 2024, and U.S. Provisional Application No. 63/657,966, entitled “Selectable Images For Association With Network Identifiers,” filed Jun. 9, 2024, the entirety of which are incorporated herein by reference.

### TECHNICAL FIELD

The present description relates generally to electronic devices, including, for example, utilizing an electronic device to compose and send a message including a network identifier associated with an image, which may be referred to as a rich link.

### BACKGROUND

The advancement of technology has brought about increased features in communication applications which can lead to a more user-friendly experience or enjoyment of user devices.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates a diagram of various example electronic devices that may implement aspects of the subject technology in accordance with one or more implementations.

FIG. 2 illustrates a data flow diagram for data at a device implementing aspects of the subject technology, in accordance with one or more implementations.

FIG. 3 illustrates a flow diagram of an example system for providing images for selection to accompany a rich link, in accordance with one or more implementations.

FIGS. 4A, 4B, 4C, and 4D illustrate examples of a user interface at various intermediate stages in the providing and selecting of an image to accompany a rich link, in accordance with one or more implementations.

FIG. 5 illustrates a process flow for implementing aspects of the subject technology in accordance with some implementations.

FIG. 6A illustrates an example electronic system with which aspects of the subject technology may be implemented in accordance with one or more implementations. FIGS. 6B and 6C illustrate flow diagrams for an application process implementing aspects of the disclosure, in accordance with some implementations. FIGS. 6D and 6E illustrate a device diagram and a system diagram, each of which implement aspects of the disclosure, in accordance with some implementations. FIGS. 6F and 6G illustrate a flow for an API calling module and API interface, which may be used in accordance with some implementations.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Many people utilize handheld and other portable devices every day for their convenience and for sending and receiving messages from others. Messaging applications installed on such devices may include a composition interface having an input element for inserting text via a keyboard-type input or via a pasting action. Sometimes content can be copied from one application and pasted into an input element of the messaging application. Sometimes content can be shared from a first application to the messaging application via a share command executed at the first application which can launch a version of the messaging application that includes the input element with the content automatically inserted into the input element.

Typically, when a user shares a URL or network address of a website a plain URL is sent. In some instances, the textual URL may automatically be linked to the corresponding webpage, but typically no context is provided for the URL other than a separate explanation provided by the sending user. Thus, when a user shares a link or uniform resource locator (URL), or other network identifier (which may generically be referred to as a URL), to a website in a message to another device, one user experience opportunity is to replace the text of the URL in the message with additional information about the website associated with the URL. For example, some websites can provide an image or icon and title which are maybe specially tagged. The plain URL augmented with information from the website may be understood to be a rich link in that the link to the website is enriched with the additional information from the website and in the subject technology the rich link may include a user-selectable image which is associated with the link or network identifier to the website or webpage. Rich links may be provided on the sending side or the receiving side. For example, a user can receive a plain URL via a messaging application and their own messaging application can provide a rich link or preview of the content at the URL by replacing the text of the URL with an image from the webpage and an excerpt from the webpage, such as a title of the webpage.

The subject technology provides the ability for a user to obtain at a device, multiple images associated with a URL, and select from among the multiple images an image for sending as part of a message containing a rich link. As used herein, images are understood to include still images, animated images, and/or videos. The subject technology provides a mechanism to obtain at least some images which are protected from anonymous access, for example, behind a credentialled login, such as behind a paywall. For example, the subject technology can obtain the images from a web browser application logged into the website using the user's valid credentials or authorized access. The subject technology further provides a mechanism to arbitrate the obtained messages, that is, filter and select candidate images for the user to choose from based on a set of filter criteria designed to provide acceptable options for selection. Upon receiving a selected image from the candidate images, the subject technology can also analyze a selected image to determine a color in the image, such as a dominant color, and to select or suggest a background color of a message container including the rich link based on the color in the image.

Therefore, the subject technology advantageously provides a technological solution for obtaining images associated with a URL, providing the images for selection by a user, and receiving the selected item. The subject technology advantageously reduces time, processing resources, memory resources, and/or battery resources by providing images which would otherwise need to be separately accessed by the user, copied or saved by the user, and then separately selected by the user in composition of a message in a messaging application.

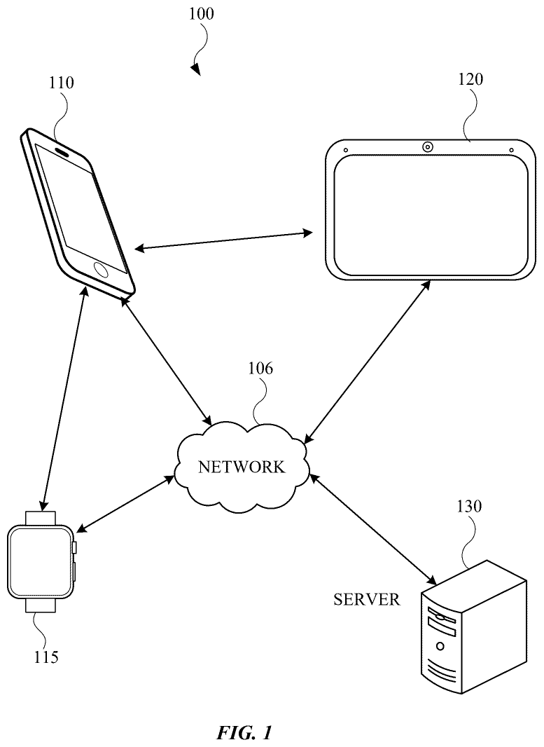

FIG. 1 illustrates an example network environment 100 in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, an electronic device 115, an electronic device 120, and a server 130. The network 106 may communicatively (directly or indirectly) couple the electronic devices 110-120 and/or the server 130. In one or more implementations, the network 106 may be an interconnected network of devices that may include, or may be communicatively coupled to, the Internet. For explanatory purposes, the network environment 100 is illustrated in FIG. 1 as including the electronic device 110, the electronic device 115, the electronic device 120, and the server 130; however, the network environment 100 may include any number of electronic devices and any number of servers or a data center including multiple servers. In some implementations one or more of the electronic devices 110-120 may not be connected to the network 106, but may be tethered to one of the other electronic devices 110-120 wirelessly or by a wired connection.

Each of the electronic devices 110-120 may be, for example, a desktop computer, a portable computing device such as a laptop computer, a smartphone, a peripheral device (e.g., a digital camera, headphones), a tablet device, a wearable device such as a watch, head mounted display, and the like. In FIG. 1, by way of example, the electronic device 110 is depicted as a mobile electronic device (e.g., smartphone), the electronic device 115 is depicted as a smart watch, and the electronic device 120 is depicted as a tablet computer. The electronic device 110, the electronic device 115, and the electronic device 120 may be, and/or may include all or part of, the electronic system discussed below with respect to FIG. 7.

In one or more implementations, one or more of the electronic devices 110-120 may provide a messaging application for composing and sending a message to another electronic device 110-120, for example, via a server 130. In one or more implementations, the sending electronic device 110-120 can send an image with a uniform resource locator (URL), the image based on the URL and obtained from images available at the URL. The sending electronic device 110-120 can provide options to a user for selecting the image to be sent with the URL via the messaging application. The user can select the image and indicate the message should be sent. The sending electronic device 110-120 can submit the message to the server 130, which can forward the message to a receiving electronic device 110-120 which can display the message in a corresponding messaging application. In one or more implementations, operations that involve individually identifiable information of a user of one or more of the electronic devices 110-120 may be performed securely or use encryption on the electronic devices 110-120, to prevent exposure of individually identifiable data to devices and/or systems that are not authorized by the user.

The server 130 may form all or part of a network of computers or a group of servers, such as in a cloud computing or data center implementation. For example, the server 130 stores data and software, and includes specific hardware (e.g., processors, graphics processors and other specialized or custom processors) for rendering and generating content such as graphics, images, video, audio and multimedia files. In an implementation, the server 130 may function as a messaging server that transmits messages content generated by the above-discussed electronic devices 110-120 and/or the server 130 to another of the above-discussed electronic devices 110-120.

In the example of FIG. 1, each of the electronic devices 110-120 are depicted as a particular type of device, e.g., smartphone, smart watch, tablet. However, it is appreciated that each of the electronic devices 110-120 may be implemented as another type of device, such as a wearable device (e.g., a smart watch or other wearable device). The electronic devices 110-120 may be a device of a user (e.g., the electronic devices 110-120 may be associated with and/or logged into a user account for the user at a server).

Each of the electronic devices 110-120, may include a body or housing containing elements such as input interfaces, output interfaces, processors, displays, processor(s), storage, system memory, read-only memory, network interfaces, and so forth, such as depicted in the electronic system discussed below with respect to FIG. 7.

To the extent that a single electronic device 110 is referenced herein, for the sake of simplicity, it is appreciated that any of the electronic devices of FIG. 1 may be utilized.

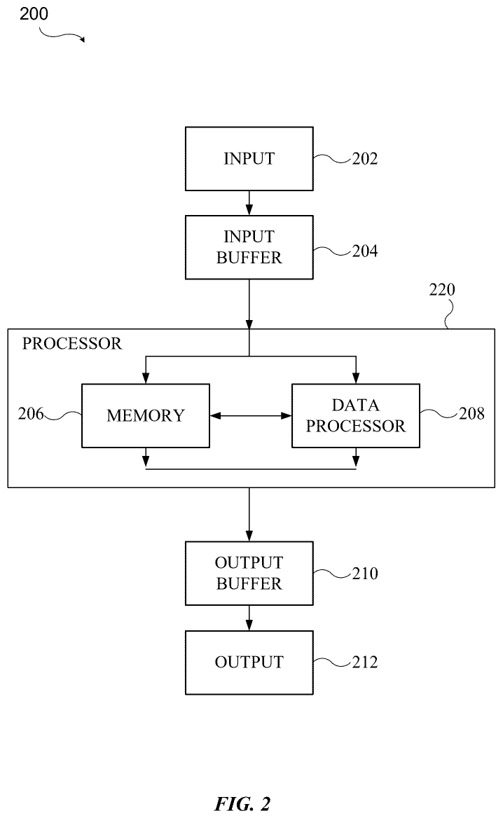

FIG. 2 illustrates data flow 200 in a device used for processing data in accordance with one or more implementations. Typical processing of data (e.g., at the electronic device 110) begins when the data is received at an input 202 and processed into an input buffer 204. The data is then transferred to a processor 220, where it is processed, and output to the output 212.

The processor 220 may include a memory 206 and a data processor 208. Depending on specific implementations, the processor 220 may also include other processors such as, for example, a graphics processor (which is not explicitly shown in FIG. 2). Thus, based on the type of device, the data processor 208 may perform, among other things, compression and/or decompression of the received data, encrypt the received data for storage, modulate or demodulate the received data, and/or perform other data manipulation.

In some implementations, each of the electronic devices 110, 115, and 120, and server 130 can include the data flow of FIG. 2. In some implementations such as a smartwatch or other secondary device, processing power, memory, and/or battery constraints may make it so that it is preferred for data processing of the message (e.g., compression or encryption) to be performed on another device, such as the electronic device 110, for example, by sending or receiving messages through the electronic device 110 to the server 130.

In some implementations, because of the environment in which the electronic devices function, the processor 220 may have limited processing resources and/or storage resources outside the processor 220 may be limited. Processing resources can include a processing unit (e.g., CPU), FPGA, ASIC, hardware electronic circuit, etc. For example, in some implementations, thousands of instances of data processing (e.g., a data encryption and/or data decrypting) may need to be performed at the same time within given memory constraints. In some implementations, the processing resources of the processor 220 include a memory 206 which may be used as a cache or to provide a data buffer for certain data processing algorithms. Storage resources outside the processing resources may include other volatile or non-volatile memory.

For example, in some implementations, while processing the received data, the data processor 208 may store some or all of received data, processed data and/or intermediate data in memory 206. The memory 206 may include RAM, ROM, and/or non-volatile memory.

Upon or during the processing of the data, the data processor 208 may write the processed data to the memory 206 and/or to an output buffer 210.

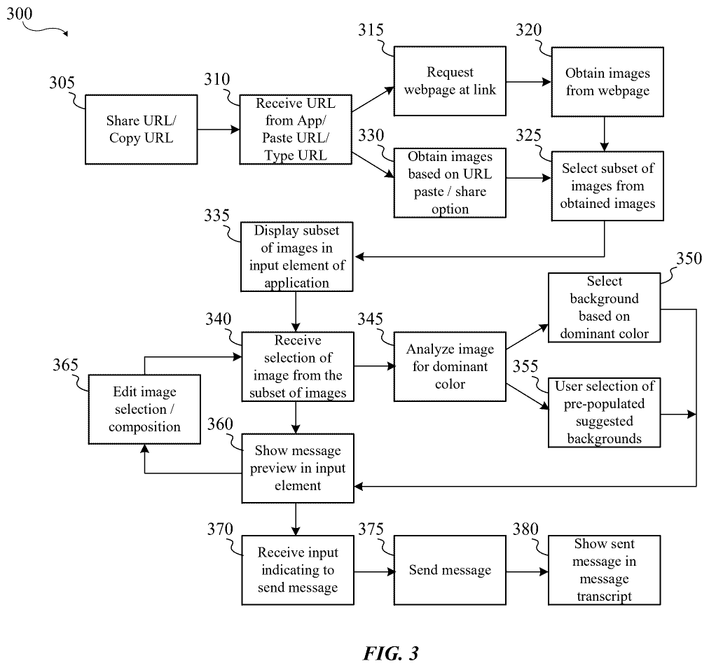

FIG. 3 illustrates a data flow diagram 300 for an example system for providing images for selection to accompany a rich link. One or more blocks (or operations) of the flow diagram of FIG. 3 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 305, a user may utilize their device (e.g., electronic device 110) to select and copy a URL from an address bar of a web browser on their device or from a textual interface selecting and copying the URL, in accordance with some implementations. In other implementations, the user may select a share command, such as a share button or share instruction, to share the webpage (e.g., URL) to another application on the device. The user may be prompted to select the application to share the webpage to and the user may select a messaging application from the available applications prompted.

At block 310, the messaging application may receive the URL. In some aspects, it may be received from a share operation of another application and be provided by a system process to accept the shared data from the source application and provide the shared data to the messaging application. In some aspects, the URL may be received by a pasting action at an input element of the messaging application. For example, a user can select an input element of the messaging application and paste the URL into the input element of the messaging application In some other aspects, the URL can be typed into the input element of the messaging application, for example, by the user selecting the input element and utilizing a software or hardware keyboard to type the URL into the input element. One or more of these aspects of receiving shared data, receiving pasted data, and receiving typed data may represent multiple modalities of interacting with the messaging application and as such may all be supported as different input mechanisms for sharing a URL.

After receiving the link at the messaging application, the messaging application may proceed to take steps to obtain images from the website corresponding to the link. Of the obtained images, one or more of the images may be presented at a subsequent process to the user for selection to include with the message sharing the URL.

The flow can split from block 310 either to block 315 or block 330. In some implementations, when the URL is shared from another application to the messaging application (URL share) or the URL is copied from another application and pasted into the messaging application (URL paste), images, animated images, or video from webpage associated with the URL, which is loaded in the other application, may be made available to the messaging application. For example, the images may be provided as metadata to the messaging application or the images may be stored in a cache memory location and the address(es) of the storage locations in the cache memory may be provided to the messaging application. In such implementations, the flow proceeds to block 330, where the images are obtained based on URL paste or URL share. In one aspect of such implementations, when a copy command or share command is received at the other application, the other application may copy the memory locations of the images associated with the web page, may copy the images themselves to a shared cache space to make them accessible to another application, or may provide the images to a system process. When a paste command is received at the messaging application or a share command provides data to the messaging application, the images may be obtained by the messaging application from the metadata, the memory address(es), the shared memory location, or the system process.

At block 315, if the URL is typed into the input element, pasted from another application that does not provide the images associated with the URL, or shared from another application that does not provide the images associated with the URL, then a process can be launched by the messaging application to request the URL at an invisible web browser (e.g., a web browser instance that is not displayed) to retrieve the images associated with the URL. The web browser can be configured to load only the top level images at the URL associated with the webpage. This can help avoid loading images associated with ads. Thus, at block 320, the images associated with the URL and webpage may be obtained via the invisible web browser process.

At block 325 a subset of the images obtained from the web page (either from block 320 or 330) can be selected. In one or more implementations, the subset can be selected based on various characteristics of the images. For example, images may be selected based on their quality, their dimensional size, their aspect ratio, and their file size, and the like. The selection can be made by filtering the images through a filter based on such criteria, and ranking the resulting images which meet the filter criteria. In some implementations, a machine learning model can be used to select and rank the obtained images. For example, the machine learning model can be trained using training images having image qualities which match the criteria. The machine learning model can then be provided the obtained images and can return a ranking based on the trained images.

In some implementations, the content characteristics of the images may be analyzed and ranked along with or in addition to the physical characteristics rankings. The content characteristics can be analyzed by an algorithm that grades the content based on a pixel analysis of the images. For example, the algorithm can grade and rank images higher with greater numbers of diverse colors, lesser numbers of diverse colors, greater or lesser chroma frequency values, greater or lesser luminescence, RGB frequency values, numbers of edges detected, other such types of pixel data, or combinations of such content aspects. In some implementations, the machine learning model mentioned above can be further trained with training images with content characteristics which are deemed to be suited for inclusion, such as aesthetically pleasing images with the content sized relatively uniformly within the composition of the images. Thus, the output of the machine learning model may include images ranked based on both the physical characteristics and the content characteristics. In other implementations, a separate machine learning model may be trained in like manner. The images may be ranked first based on either the physical characteristics or the content characteristics and then revised based on the other of the physical characteristics or the content characteristics.

A subset of the images obtained from the webpage may be selected based on the ranking. For example, the top ranked 1, 2, 3, or 4 images may be selected as the subset of the images. The subset of images may be reformatted to a final image size. In some implementations the formatting can include resizing the images to a width based on screen dimensions and resolution of the user device. In some implementations, the formatting can include cropping one or more of the images to obtain a more suited portion of the images or to control a height of the image. In some implementations, the formatting can include stretching or shrinking the images in a suitable manner for the input element of the messaging application.

At block 335, after the subset of images are selected from the obtained images, the subset of images may be displayed in the input element of the messaging application in an interface provided for user selection of one of the images for inclusion with the message. If there is only one image in the subset of images, the image can be taken as being the selected image and flow can proceed to block 360 or 345. When the subset of images contains 2 or more images, the subset of images may be displayed according to any suitable arrangement. For example, the subset of the images may be provided one on top of another, side-by-side, or in a grid in the input element.

At block 340, an indication of a selection of an image from the subset of images may be received by the messaging application. For example, a user can tap on an image to select the image. In some implementations, multiple images may be selected, and a layout of the multiple images may be used instead of a single image, for example by combining the images into a grid layout. A new image may be generated instead by combining the content of the multiple selected images to create an amalgamation of the selected images. The flow can continue to an optional set of processes related to the background color of the message at block 345 or the flow can forgo the processes related to background color and the flow can continue to block 360.

At block 345, upon selection of the image at block 335 the image can be analyzed at block 345 for a dominant color of the image. Then, at block 350 a background color can be automatically selected based on the dominant color of the image, in accordance with some implementations. In other implementations, at block 355 a selection of pre-populated suggested backgrounds can be provided and the user can choose which of these background colors should be applied. Returning to block 345, the dominant color can be a color which is most occurring in the image or a color which has a largest grouping of pixels thereof. In some implementations, the various colors of the selected image may be fitted into a simplified color palette and the dominant color of the selected image may be based on the simplified color palette.

At block 350, the selected background color can be based on the dominant color and may be for example, the same as the dominant color, a contrasting color to the dominant color, a complimentary color to the dominant color, a negative of the dominant color, and so forth. In some implementations a gradient may be applied to the background between two colors, each based on a dominant color of the selected image, when more than one dominant color is determined. At block 355, the selection of a background color can be obtained from a pre-populated group of suggested background colors based on the dominant color, such as between the dominant color, a contrasting color to the dominant color, a complimentary color to the dominant color, a negative color to the dominant color, or the like. The selection may also include other pre-populated suggested colors and a color picker tool.

At block 360, the text of the URL supplied to the messaging application in the input element may be supplemented with or replaced by the selected image, optionally the title of the webpage, and optionally the background color. The message may be arranged in a message container that also includes at least a link to the URL, either hidden or plainly represented in the message container. The link to the URL can be accessed, for example, by clicking or tapping on the image or a title element in the message container. The message container can be provided in the input element so that a preview of the message to be sent, including the selected image and optionally the title associated with the URL can be seen in the message container. The selected image may be shown in the input element at a different width than was shown when the image was shown in the subset of images.

In some implementations, an input control can be provided near the message preview to allow the user to proceed to block 365 to edit the image selection of the subset of images and/or edit the composition of the selected image, for example, by cropping the image, resizing the image, recoloring the image, providing an annotation over the image, or the like, or combinations thereof. In such implementations, the flow will proceed back to block 340, such as described above.

At block 370, an input is received which indicates to the system to send the message, including the message container, the message container containing a rich link including an image associated with a webpage, a title of the web page, and a URL to the webpage.

At block 375, in response to receiving the input indicating to send the message, sending the message to another device, for example a server device, which will in turn send it to another user device.

At block 380, in response to receiving the input indicating to send the message, the message container displayed in the input element is moved to the message transcript of the messaging application.

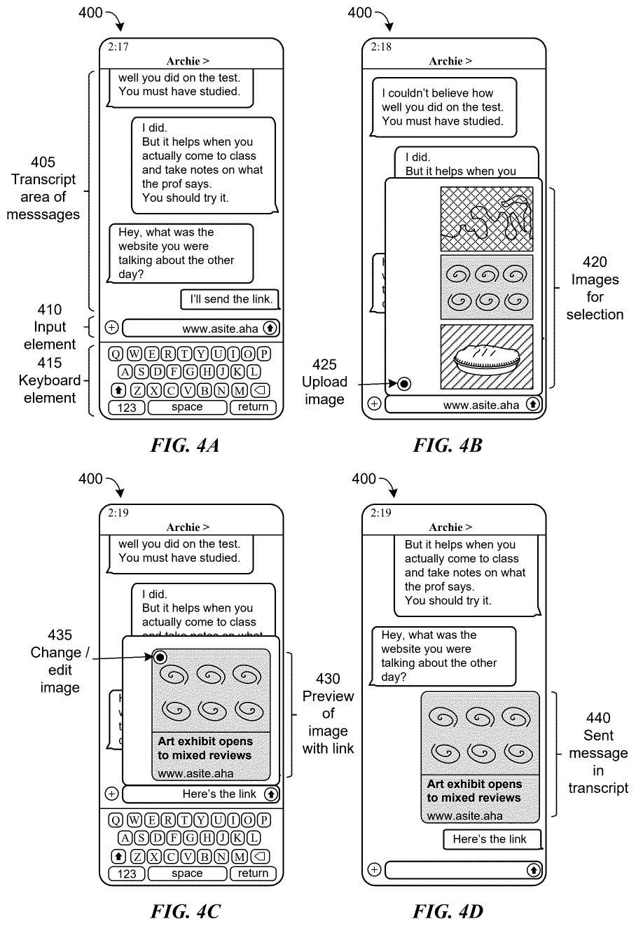

FIGS. 4A, 4B, 4C, and 4D illustrate example interfaces which demonstrate a visual representation of the flow discussed above with respect to the data flow diagram 300 of FIG. 3, in accordance with some embodiments. FIGS. 4A, 4B, 4C, and 4D each illustrate an interface 400 of a messaging application, in accordance with some embodiments. It is appreciated that the drawings of FIGS. 4A, 4B, 4C, and 4D need not include all the features illustrated and discussed below and may include other features and elements which are not provided for the sake of simplicity.

Each of the FIGS. 4A, 4B, 4C, and 4D include various elements of the interface 400, including a transcript area 405 for messages which can hold therein a transcript of a conversation with a contact or group. An input element 410 may be provided where users can provide text or other items which are to be sent in the messaging application. A keyboard element 415 may be provided which corresponds to a software keyboard for providing text input to the input element 410.

FIG. 4A illustrates that a URL has been entered into the input element 410, in accordance with some implementations, such as discussed above with respect to the blocks 310. In particular, the state of FIG. 4A includes that the text illustrated as being entered into the input interface may be entered by any of the mechanisms previously discussed, such as by typing, pasting, or sharing from another application.

In response to receiving the URL, images based on the URL or associated with the URL are obtained, as noted above, for example, with respect to blocks 315, 320, and 330. And a subset of the obtained images can be selected, such as described above with respect to block 325.

FIG. 4B illustrates that the subset of images 420 can be displayed in the interface 400 in the input element 410 of the interface 400. The subset of images 420 can be selected using a suitable process such as described above with respect to the block 325. In the illustration of FIG. 4B, the subset of images 420 includes three images shown one on top of the other. A fourth image can be understood as being off screen and accessible by scrolling the content in the input element 410. Each of the images in the subset of images 420 are shown with a background shade or pattern that represents a background color. Each of the images are shown to have uniform widths to each other. The widths of each image of the subsets of images 420 can be normalized relative to a standard width or relative to each other; the standard width, if used, can be based in part on the screen physical characteristics of the device displaying the subset of images.

One or more of the images of the subset of images 420 can include still (jpg, png, bmp, svg, etc.) or moving images (gif, animated svg, animated png, mov, mp4, etc.). One or more of the images of the subset of images 420 may only be accessible through a credentialed access of the URL from which they come. For example, a user id and password or access token may be required to access the page to obtain the images. In such implementations, the images can be sent as part of a share command or copy and paste command in a supported web browser application. The arrangement of the subset of images 420 may be altered. In some implementations, one or more of the images of the subset of images 420 may be arranged in a grid layout, such as a grid of four images. The grid layout may include two side-by-side and one above or below the two side-by-side.

FIG. 4B also illustrates a selectable element 425 to upload an image to be included in the subset of images 420. When a user engages the selectable element 425, an interface can be displayed that provides the user the ability to select from their own media (or the set of their own media which the messaging application has permission to access), an image to include in the subset of images 420. Upon selection of a media item to include in the subset of images 420, the messaging application can alter the media item to crop the media item and/or adjust the dimensions or resolution of the media item, such as described above with respect to the subset of images. Upon selection of an image from the subset of images 420, such as described above with respect to block 340, processes to determine a dominant color and choose a background color based at least in part on the dominant color may be performed, such as described above with respect to the blocks 345, 350, and 355. Upon completion of the determining or selecting of the background color based on the image selected, an interface 400 similar to that illustrated in FIG. 4C can be displayed.

FIG. 4C illustrates a preview of the message to be sent to one or more devices. The preview can include a message container 430 which includes the selected image, the title of the webpage (or a representation such as an abbreviated portion thereof), and optionally at least a partial display of the URL, such as a display of the site domain (e.g., “asite” as illustrated in FIG. 4C) and top level domain (e.g., “aha” as illustrated in FIG. 4C). The message container 430 may also include metadata which includes the full URL which can be sent with the message container 430 so that the receiving user can tap on the received message and navigate directly to the URL. A selectable element 435 is also illustrated, which when selected causes the device to provide customization options, such as described above with respect to block 365, for example, to annotate an image, change a background color, change the selected image, change the title, and so forth. In some implementations, the input element 410 can provide the ability to accept additional input from the user, such as an additional comment and/or an additional URL. If an additional URL is input, the process described herein for selecting an image for the additional URL may be performed again.

FIG. 4D illustrates the transcript area 405 having the message container displayed therein which may be performed upon executing a send command. Thus, FIG. 4D illustrates that, upon executing a send command for the message, the message container can be moved from the input element 410 to the transcript area 405 of the interface 400 to be displayed as the sent message 440. Additional content that is also sent may be moved to the transcript area 405. If the user selects the sent message 440 from the transcript area 405, the user may be directed to a web browser application which loads the URL.

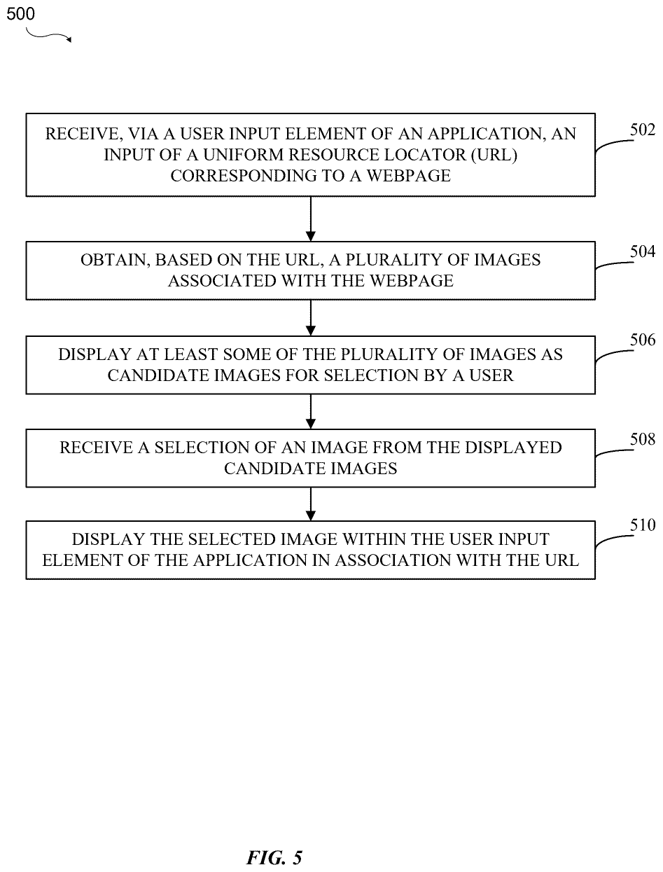

FIG. 5 illustrates a flow of an example process 500 for sending a rich link having a user-selectable image, in accordance with some embodiments. One or more blocks (or operations) of the process flow diagram of FIG. 5 may be performed by one or more other components and other suitable devices. Further for explanatory purposes, the blocks are described herein as occurring in serial, or linearly. However, multiple blocks of the process may occur in parallel. In addition, the blocks of the process need not be performed in the order shown and/or one or more blocks of the process need not be performed and/or can be replaced by other operations.

At block 502, the process 500 may include receiving, via a user input element of an application, an input of an uniform resource locator (URL) corresponding to a webpage. For example, a device, such as the electronic device 110, may receive the URL via a user input element via a keyboard, a paste command, or a share command, such as described above with respect to block 310.

At block 504, the process 500 may include obtaining, based on the URL, a plurality of images associated with the webpage. For example, the device may obtain the images by fetching the webpage associated with the URL and retrieving the images associated with the URL, such as described above with respect to blocks 315 and 320 or may obtain the images based on a paste command or share command where the images are provided or made available via the paste command or share command, such as described above with respect to block 330. In some aspects, the images obtained can be only obtainable utilizing user credentials. In such aspects, the user credentials can include a user session, login id and password, or access token used to obtain the images by obtaining the images via a web browser application running on the device.

At block 506, the process 500 may include displaying at least some of the plurality of images as candidate images for selection by a user. For example, the device may select a subset of the plurality of images as candidate images, such as described with respect to block 325, and may display at least some of the plurality of images as candidate images for selection by a user at the user device, such as described with respect to block 335. In some aspects, the candidate images can be displayed in the user input element or in another different user input element. The candidate images can be displayed in any format, including in a stack of images, side-by-side, or in a grid layout.

The candidate images may be selected as a subset of the obtained images for display by analyzing each image of the obtained plurality of images against a set of criteria, the set of criteria including image size and image quality, ranking the obtained plurality of images based on the set of criteria, and selecting the candidate images based on the ranking, such as described with respect to block 325. The set of criteria can also include the content of the image.

At block 508, the process 500 may include receiving a selection of an image from the displayed candidate images. For example, a user may select from among the candidate images, an image for inclusion in a rich link, such as described with respect to block 340.

At block 510, the process 500 may include displaying the selected image within the user input element of the application in association with the URL. For example, the device may display the selected image within the user input element of the application in association with the URL. For example, the URL can be replaced in the user input element with the selected image, such as described with respect to block 360. In some implementations, a title or description for the associated webpage can also be included in the user input element. A representation of the URL may also be included, such as at least a portion of the URL or an abbreviated version of the URL. In some implementations, the image which was displayed as a candidate image may be smaller than the image that is provided as the selected image. For example, if the image displayed as a candidate image was displayed in a grid layout, while in the grid layout, it may be scaled smaller than when the image is displayed in the user input element as a selected image from the candidate images.

In some aspects, the selected image can be analyzed to determine a dominant color or another color of the image, and a message container including the rich link can be displayed as having a fill color based on the dominant color. The fill color may correspond to the dominant color, a contrasting color to the dominant color, or a complimentary color to the dominant color. Such aspects may be implemented such as described with respect to blocks 345, 350, and 355. In some aspects, the image can be a composite of multiple images, include an annotation, or may be edited, such as described with respect to block 365.

In some aspects, a request can be received to transmit the message container including the selected image. Responsive to receiving the request, the message container can be transmitted by the messaging application, the message container including the selected image in association with the URL to another device. Further responsive to receiving the request, a display of the message container in the input element can be moved to a message transcript element of the application.

As described above, one aspect of the present technology is the gathering and use of data available from specific and legitimate sources for providing images for selection by a user obtained via electronic devices. The present disclosure contemplates that in some instances, this gathered data may include personal information data that uniquely identifies or can be used to identify a specific person. Such personal information data can include voice data, demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used for providing user selected, user provided, and/or user controlled images to another based on inputs from the user. Accordingly, use of such personal information data may facilitate transactions (e.g., on-line transactions).

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of operating an electronic device to provide user supplied images or annotations, the present technology can be configured to allow users to select to “opt in” or “opt out” of participation in the collection of personal information data during access to user-controlled photo libraries or inputs. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

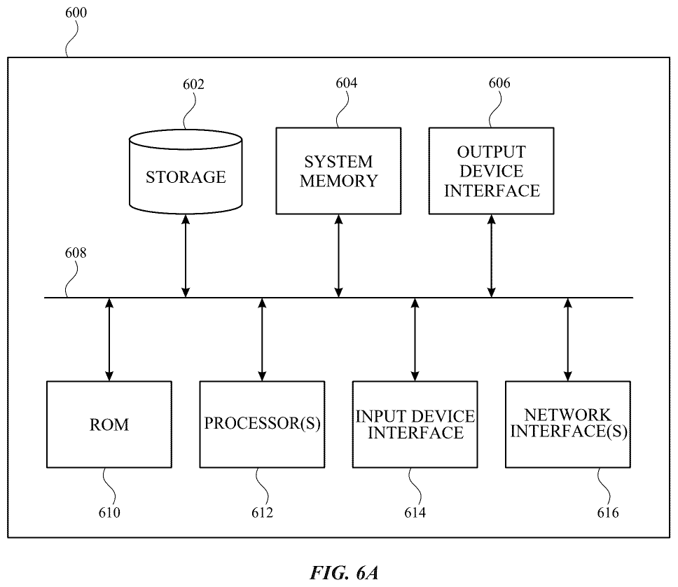

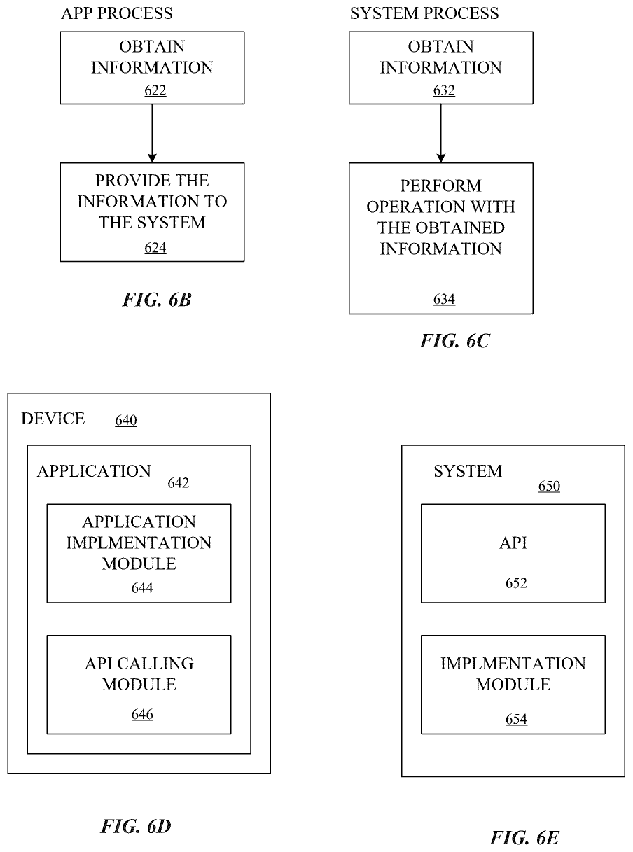

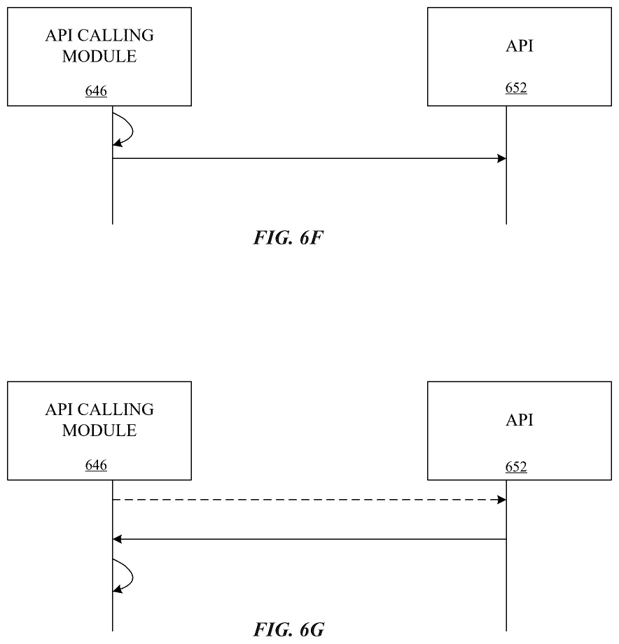

FIG. 6A illustrates an electronic system 600 with which one or more implementations of the subject technology may be implemented. The electronic system 600 can be, and/or can be a part of, one or more of the electronic devices 110, 115, and/or 120. The electronic system 600 may include various types of computer readable media and interfaces for various other types of computer readable media. The electronic system 600 includes a bus 608, one or more processing unit(s) 612, a system memory 604 (and/or buffer), a ROM 610, a permanent storage device 602, an input device interface 614, an output device interface 606, and one or more network interfaces 616, or subsets and variations thereof.

The bus 608 collectively represents all system, peripheral, and chipset buses that communicatively connect the numerous internal devices of the electronic system 600. In one or more implementations, the bus 608 communicatively connects the one or more processing unit(s) 612 with the ROM 610, the system memory 604, and the permanent storage device 602. From these various memory units, the one or more processing unit(s) 612 retrieves instructions to execute and data to process in order to execute the processes of the subject disclosure. The one or more processing unit(s) 612 can be a single processor or a multi-core processor in different implementations.

The ROM 610 stores static data and instructions that are needed by the one or more processing unit(s) 612 and other modules of the electronic system 600. The permanent storage device 602, on the other hand, may be a read-and-write memory device. The permanent storage device 602 may be a non-volatile memory unit that stores instructions and data even when the electronic system 600 is off. In one or more implementations, a mass-storage device (such as a magnetic or optical disk and its corresponding disk drive) may be used as the permanent storage device 602.

In one or more implementations, a removable storage device (such as a flash drive) may be used as the permanent storage device 602. Like the permanent storage device 602, the system memory 604 may be a read-and-write memory device. However, unlike the permanent storage device 602, the system memory 604 may be a volatile read-and-write memory, such as random access memory. The system memory 604 may store any of the instructions and data that one or more processing unit(s) 612 may need at runtime. In one or more implementations, the processes of the subject disclosure are stored in the system memory 604, the permanent storage device 602, and/or the ROM 610. From these various memory units, the one or more processing unit(s) 612 retrieves instructions to execute and data to process in order to execute the processes of one or more implementations.

The bus 608 also connects to the input and output device interfaces 614 and 606. The input device interface 614 enables a user to communicate information and select commands to the electronic system 600. Input devices that may be used with the input device interface 614 may include, for example, alphanumeric keyboards and pointing devices (also called “cursor control devices”). The output device interface 606 may enable, for example, the display of images generated by electronic system 600. Output devices that may be used with the output device interface 606 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 6A, the bus 608 also couples the electronic system 600 to one or more networks and/or to one or more network nodes, through the one or more network interface(s) 616. In this manner, the electronic system 600 can be a part of a network of computers (such as a LAN, a wide area network (“WAN”), or an Intranet, or a network of networks, such as the Internet. Any or all components of the electronic system 600 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules and/or components.

Implementations within the scope of the present disclosure include a computer-readable storage medium that encodes instructions organized as an application (e.g., application 642) that, when executed by one or more processing units, control device 640) to perform the method of FIG. 6B, the method of FIG. 6C, and/or one or more other processes and/or methods described herein.

It should be recognized that application 642 (shown in FIG. 6D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 642 is an application that is pre-installed on device 640 at purchase (e.g., a first party application). In other embodiments, application 642 is an application that is provided to device 640 via an operating system update file (e.g., a first party application or a second party application). In some embodiments, application 642 is an application that is provided via an application store. In some embodiments, the application store can be an application store that is pre-installed on device 640 at purchase (e.g., a first party application store). In some embodiments, the application store is a third-party application store (e.g., an application store that is provided by another application store, downloaded via a network, and/or read from a storage device).

Referring to FIG. 6B and FIG. 6F, application 642 obtains information (e.g., 622). In some embodiments, at 622, information is obtained from at least one hardware component of the device 640. In some embodiments, at 622, information is obtained from at least one software module (e.g., set of instructions) of the device 640. In some embodiments, at 622, information is obtained from at least one hardware component external to the device 640 (e.g., a peripheral device, an accessory device, and/or a server). In some embodiments, the information obtained at 622 includes positional information, time information, notification information, user information, environment information, electronic device state information, weather information, media information, historical information, event information, hardware information, and/or motion information. In some embodiments, in response to and/or after obtaining the information at 622, application 642 provides the information to a system (e.g., 624).

In some embodiments, the system (e.g., 650 shown in FIG. 6E) is an operating system hosted on the device 640. In some embodiments, the system (e.g., 650 shown in FIG. 6E) is an external device (e.g., a server, a peripheral device, an accessory, and/or a personal computing device) that includes an operating system.

Referring to FIG. 6C and FIG. 6G, application 642 obtains information (e.g., 632). In some embodiments, the information obtained at 632 includes positional information, time information, notification information, user information, environment information, electronic device state information, weather information, media information, historical information, event information, hardware information and/or motion information. In response to and/or after obtaining the information at 632, application 642 performs an operation with the information (e.g., 634). In some embodiments, the operation performed at 634 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 650 based on the information.

In some embodiments, one or more steps of the method of FIG. 6B and/or the method of FIG. 6C is performed in response to a trigger. In some embodiments, the trigger includes detection of an event, a notification received from system 650, a user input, and/or a response to a call to an API provided by system 650.

In some embodiments, the instructions of application 642, when executed, control device 640 to perform the method of FIG. 6B and/or the method of FIG. 6C by calling an application programming interface (API) (e.g., API 652) provided by system 650. In some embodiments, application 642 performs at least a portion of the method of FIG. 6B and/or the method of FIG. 6C without calling API 652.

In some embodiments, one or more steps of the method of FIG. 6B and/or the method of FIG. 6C includes calling an API (e.g., API 652) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 6D, device 640 is illustrated. In some embodiments, device 640 is a personal computing device, a smart phone, a smart watch, a fitness tracker, a head mounted display (HMD) device, a media device, a communal device, a speaker, a television, and/or a tablet. Device 640 includes application 642 and an operating system (not shown) (e.g., system 650 shown in FIG. 6E). Application 642 includes application implementation instructions 644 and API calling instructions 646. System 650 includes API 652 and implementation instructions 654. It should be recognized that device 640, application 642642, and/or system 650 can include more, fewer, and/or different components than illustrated in FIGS. 6D and 6E.

In some embodiments, application implementation instructions 644 is a software module that includes a set of one or more computer-readable instructions. In some embodiments, the set of one or more instructions of instructions 644 correspond to one or more operations performed by application 642. For example, when application 642 is a messaging application, application implementation instructions 644 can include operations to receive and send messages. In some embodiments, application implementation instructions 644 communicates with API calling instructions to communicate with system 650 via API 652 (shown in FIG. 6E).

In some embodiments, API-calling instructions 646 is a software module that includes a set of one or more computer-executable instructions.

In some embodiments, implementation instructions 654 is a software module that includes a set of one or more computer-executable instructions.

In some embodiments, API 652 is a software module that includes a set of one or more computer-executable instructions. In some embodiments, API 652 provides an interface that allows a different set of instructions (e.g., API calling instructions 646) to access and/or use one or more functions, methods, procedures, data structures, classes, and/or other services provided by implementation instructions 654 of system 650. For example, API-calling instructions 646 can access a feature of implementation instructions 654 through one or more API calls or invocations (e.g., embodied by a function or a method call) exposed by API 652 and can pass data and/or control information using one or more parameters via the API calls or invocations. In some embodiments, API 652 allows application 642 to use a service provided by a Software Development Kit (SDK) library. In some embodiments, application 642 incorporates a call to a function or method provided by the SDK library and provided by API 652 or uses data types or objects defined in the SDK library and provided by API 652. In some embodiments, API-calling instructions 646 makes an API call via API 652 to access and use a feature of implementation instructions 654 that is specified by API 652. In such embodiments, implementation instructions 654 can return a value via API 652 to API-calling instructions 646 in response to the API call. The value can report to application 642 the capabilities or state of a hardware component of device 640, including those related to aspects such as input capabilities and state, output capabilities and state, processing capability, power state, storage capacity and state, and/or communications capability. In some embodiments, API 652 is implemented in part by firmware, microcode, or other low level logic that executes in part on the hardware component.

In some embodiments, API 652 allows a developer of API-calling instructions 646 (which can be a third-party developer) to leverage a feature provided by implementation instructions 654. In such embodiments, there can be one or more sets of API-calling instructions (e.g., including API-calling instructions 646) that communicate with implementation instructions 654. In some embodiments, API 652 allows multiple sets of API-calling instructions written in different programming languages to communicate with implementation instructions 654 (e.g., API 652 can include features for translating calls and returns between implementation instructions 654 and API-calling instructions 646) while API 652 is implemented in terms of a specific programming language. In some embodiments, API-calling instructions 646 calls APIs from different providers such as a set of APIs from an OS provider, another set of APIs from a plug-in provider, and/or another set of APIs from another provider (e.g., the provider of a software library) or creator of the another set of APIs.

Examples of API 652 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 640. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 654 is a system (e.g., operating system, server system) software module (e.g., a collection of computer-readable instructions) that is constructed to perform an operation in response to receiving an API call via API 652. In some embodiments, implementation instructions 654 is constructed to provide an API response (via API 652) as a result of processing an API call. By way of example, implementation instructions 654 and API-calling instructions 646 can each be any one of an operating system, a library, a device driver, an API, an application program, or other module. It should be understood that implementation instructions 654 and API-calling instructions 646 can be the same or different type of software module from each other. In some embodiments, implementation instructions 654 is embodied at least in part in firmware, microcode, or other hardware logic.

In some embodiments, implementation instructions 654 returns a value through API 652 in response to an API call from API-calling instructions 646. While API 652 defines the syntax and result of an API call (e.g., how to invoke the API call and what the API call docs), API 652 might not reveal how implementation instructions 654 accomplishes the function specified by the API call. Various API calls are transferred via the one or more application programming interfaces between API-calling instructions 646 and implementation instructions 654. Transferring the API calls can include issuing, initiating, invoking, calling, receiving, returning, and/or responding to the function calls or messages. In other words, transferring can describe actions by either of API-calling instructions 646 or implementation instructions 654. In some embodiments, a function call or other invocation of API 652 sends and/or receives one or more parameters through a parameter list or other structure.

In some embodiments, implementation instructions 654 provides more than one API, each providing a different view of or with different aspects of functionality implemented by implementation instructions 654. For example, one API of implementation instructions 654 can provide a first set of functions and can be exposed to third party developers, and another API of implementation instructions 654 can be hidden (e.g., not exposed) and provide a subset of the first set of functions and also provide another set of functions, such as testing or debugging functions which are not in the first set of functions. In some embodiments, implementation instructions 654 calls one or more other components via an underlying API and thus be both a set of API calling instructions and a set of implementation instructions. It should be recognized that implementation instructions 654 can include additional functions, methods, classes, data structures, and/or other features that are not specified through API 652 and are not available to API calling instructions 646. It should also be recognized that API calling instructions 646 can be on the same system as implementation instructions 654 or can be located remotely and access implementation instructions 654 using API 652 over a network. In some embodiments, implementation instructions 654, API 652, and/or API-calling instructions 646 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, the process 500 (FIG. 5) is performed at a first computer system (as described herein) via a system process (e.g., an operating system process, a server system process) that is different from one or more applications executing and/or installed on the first computer system.

In some embodiments, the process 500 (FIG. 5) is performed at a first computer system (as described herein) by an application (e.g., a trusted application, such as one provided or verified by the manufacturer of the system) that is different from a system process. In some embodiments, the instructions of the application, when executed, control the first computer system to perform process 500 (FIG. 5) by calling an application programming interface (API) provided by the system process. In some embodiments, the application performs at least a portion of process 500 without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the process 500 (FIG. 5) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

An API that can be called, for example, can correspond to an API provided to retrieve web page and/or web site information, an API provided to parse the web page and/or web site information, an API provided to analyze images and extract features therefrom and/or classify objects within the images, and an API provided to interact with messaging elements, one or more of which can be used in conjunction with the processes and features described above.

As described above, in some embodiments, the application controls the first computer system to perform process 500 (FIG. 5) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, the API 652 defines a first API call API calling instructions 646, wherein the definition for the first API call specifies the relevant call parameters according to those variables and elements discussed above.

In some embodiments, the API 652 defines a first API call response that can be provided to the application by API calling instructions 646, wherein the first API call response provides responsive communications and outputs corresponding to the processes discussed above.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 640) that runs the application. In some embodiments, the set of implementation instructions is included in an electronic device that is separate from the device that runs the application.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
receiving, via a user input element of an application, an input of a uniform resource locator (URL) corresponding to a webpage;
obtaining, based on the URL, a plurality of images associated with the webpage;
displaying at least some of the plurality of images as candidate images for selection by a user;
receiving a selection of an image from the displayed candidate images; and
displaying the selected image within the user input element of the application in association with the URL.

2. The method of claim 1, wherein the application comprises a messaging application and the selected image is displayed as part of a message container with the user input element.

3. The method of claim 2, further comprising:
analyzing the selected image to determine a dominant color; and
displaying the message container as having a fill color based on the dominant color, wherein the fill color corresponds to the dominant color, a contrasting color to the dominant color, or a complimentary color to the dominant color.

4. The method of claim 2, further comprising:
receiving a request to transmit the message container including the selected image;
responsive to receiving the request, transmitting, by the messaging application, the message container including the selected image in association with the URL to another device; and
responsive to receiving the request to transmit the message container, moving a display of the message container in the input element to a message transcript element of the application.

5. The method of claim 1, wherein displaying the at least some of the plurality of images as the candidate images for selection by the user comprises:
displaying, within the user input element, the at least some of the plurality of images as the candidate images for selection by the user.

6. The method of claim 5, wherein the candidate images are displayed within the user input element in a grid layout.

7. The method of claim 6, further comprising, after receiving the selection of the image, replacing the candidate images with the selected image in the user input element in a larger format than a representation of the selected image in the grid layout.

8. The method of claim 1, wherein obtaining, based on the URL, the plurality of images associated with the webpage further comprises:
fetching the webpage using the URL to obtain the plurality of images associated with the webpage.

9. The method of claim 8, wherein displaying the at least some of the plurality of images as the candidate images for selection by the user comprises:
analyzing each image of the obtained plurality of images against a set of criteria, the set of criteria comprising image size and image quality;
ranking the obtained plurality of images based on the set of criteria; and
selecting the candidate images based on the ranking.

10. The method of claim 9, wherein the set of criteria further comprises image content.

11. The method of claim 1, wherein the URL is received via the user input element by a pasting action.

12. The method of claim 11, further comprising:
receiving, at the application from another application from which the URL was copied, along with the URL, the plurality of images associated with the webpage.

13. The method of claim 12, wherein the URL was copied from the other application while the other application was displaying the webpage based on credentials allowing access to the webpage.

14. The method of claim 13, wherein at least one of the plurality of images associated with the webpage are not available without credentials allowing access to at least a portion of the webpage.

15. The method of claim 1, wherein the selected image for display comprises a composite of at least two of the candidate images.

16. The method of claim 1, further comprising:
prior to displaying the at least some of the plurality of images, adjusting one or more of the plurality of images, the adjusting comprising: altering the one or more of the plurality of images so that each of the plurality of images have the same width.

17. The method of claim 16, wherein the adjusting further comprises cropping the one or more of the plurality of images.

18. A system comprising:
one or more processors; and
a computer-readable medium, wherein the one or more processors are configured to perform operations comprising:
receiving, via a user input element of an application, an input of a uniform resource locator (URL) corresponding to a webpage;
obtaining, based on the URL, a plurality of images associated with the webpage;
displaying at least some of the plurality of images as candidate images for selection by a user;
receiving a selection of an image from the displayed candidate images; and
displaying the selected image within the user input element of the application in association with the URL.

19. A non-transitory computer-readable medium storing instructions thereon, which when executed by one or more processors, cause the one or more processors to perform operations comprising:
in response to providing first information to an operating system, obtaining second information, wherein the first information corresponds to a URL received at a messaging interface, wherein the second information corresponds to two or more image elements retrieved from the URL; and
displaying the two or more image elements in the messaging interface;
receiving an input indicating a selection of one image element of the two or more image elements; and
replacing the two or more image elements with the selected one image element.

20. The non-transitory computer-readable medium of claim 19, wherein the first information is provided via a sharing link causing the messaging interface to become active or via a paste operation executed in the messaging interface.
